(19) United States
(12) Patent Application Publication
(10) Pub. No.: US 2009/0061155 A1
(43) Pub. Date: Mar. 5, 2009

(54) RESIN SURFACE LAYER AND METHOD OF FABRICATING THE SAME, COMPOSITE HAVING THE RESIN SURFACE LAYER AND METHOD OF FABRICATING THE SAME

(75) Inventors: Chung-Chih FENG, Kaohsiung (TW); Pai-Hsiang WU, Kaohsiung (TW); Chien-Chia HUANG, Kaohsiung (TW); Cheng-Chi WU, Kaohsiung (TW); Chih-Shih WANG, Kaohsiung (TW)

Correspondence Address: VOLENTINE & WHITT PLLC, ONE FREEDOM SQUARE, 11951 FREEDOM DRIVE SUITE 1260, RESTON, VA, 20190, US

(73) Assignee: SAN FANG CHEMICAL INDUSTRY CO., LTD., Kaohsiung (TW)

(21) Appl. No.: 11/959,609

(22) Filed: Dec. 19, 2007

(30) Foreign Application Priority Data
Sep. 5, 2007 (TW) 096132988

(51) Int. Cl. B32B 3/10; B05D 1/12; B32B 37/12

(52) U.S. Cl. 428/141; 427/180; 156/230

(57) ABSTRACT

A resin surface layer and a method of fabricating the same, and a composite having the resin surface layer and a method of fabricating the same are provided. The method of fabricating the resin surface layer includes: (a) providing a base, made of a resin and including a plurality of additive particles randomly distributed in the base; (b) changing the orientation of the additive particles to arrange the additive particles in a predetermined form; and (c) drying the base to make a surface of the base exhibit a visual effect of 3D texture. Thus, the visual effect of any 3D texture can be achieved by controlling the orientation of the additive particles.

### BACKGROUND OF THE INVENTION

1. Field of the Invention

The present invention relates to a resin surface layer and a method of fabricating the same. More particularly, the present invention relates to a resin surface layer not having a physical texture of bumps and pits but capable of exhibiting a visual effect of 3D texture and a method of fabricating the same.

2. Description of the Related Art

FIG. 1 shows a schematic cross-sectional view of a conventional composite. The conventional composite 1 is artificial leather, including a bottom cloth layer 11, an intermediate layer 12, and a surface layer 13. The bottom cloth layer 11 generally is a woven fabric, a nonwoven fabric, leather, a microfiber, or a resin. The intermediate layer 12 is formed on the bottom cloth layer 11, and generally is a foam layer. The surface layer 13 is located on the intermediate layer 12 and is made of PU resin.

In order to improve the real-life quality of the conventional composite 1, a texture 14 is formed on the surface of the surface layer 13. The texture 14 is a physical texture of bumps and pits which is mostly formed by means of texture contact and transfer, such as printing, embossing, or release paper laminating, or directly polishing the surface of the surface layer 13. However, the above methods of forming a texture have the following shortcomings. First, the methods will influence the surface flatness of the surface layer 13. Second, the pattern of the formed texture is limited, and the 3D textures cannot be achieved.

Therefore, it is necessary to provide a resin surface layer and a method of fabricating the same to solve the above problems.

### SUMMARY OF THE INVENTION

The present invention is directed to providing a method of fabricating a resin surface layer, which includes: (a) providing a base, made of a resin and including a plurality of additive particles randomly distributed in the base; (b) changing the orientation of the additive particles to arrange the additive particles in a predetermined form; and (c) drying the base to make a surface of the base exhibit a visual effect of 3D texture. Thus, the visual effect of any 3D textures can be achieved by controlling the orientation of the additive particles.

The present invention is further directed to providing a resin surface layer, which includes a base and a plurality of additive particles. The base has a surface and is made of a resin. The additive particles are arranged in a predetermined form instead of randomly distributed in the base, so that the surface of the base exhibits a visual effect of 3D texture.

The present invention is still directed to provide a composite having the above resin surface layer.

### BRIEF DESCRIPTION OF THE DRAWINGS

FIG. 1 is a schematic cross-sectional view of a conventional composite;

FIGS. 2 to 4 are schematic views illustrating a method of fabricating a resin surface layer according to a first embodiment of the present invention;

FIG. 5 is a schematic view of a resin surface layer according to a second embodiment of the present invention;

FIG. 6 is a schematic view illustrating a resin surface layer according to a third embodiment of the present invention;

FIGS. 7 and 8 are schematic views illustrating a method of fabricating the composite having a resin surface layer according to the first embodiment of the present invention;

FIGS. 9 and 10 are schematic views illustrating a method of fabricating the composite having a resin surface layer according to the second embodiment of the present invention;

FIGS. 11 and 12 are schematic views illustrating a method of fabricating the composite having a resin surface layer according to the third embodiment of the present invention; and

FIGS. 13 to 15 are schematic views of a method of fabricating the composite having a resin surface layer according to the fourth embodiment of the present invention.

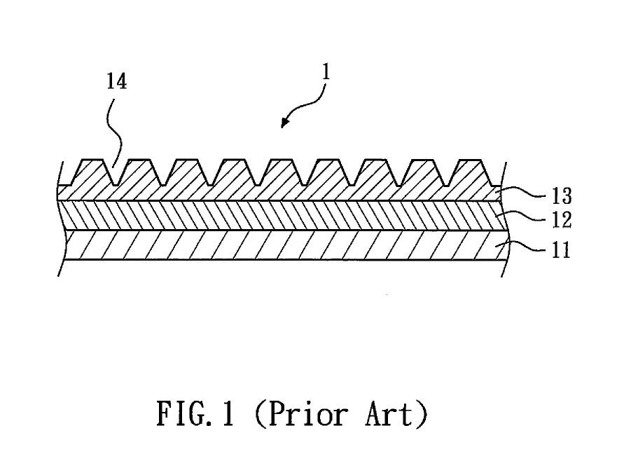

### DETAILED DESCRIPTION OF THE INVENTION

The present invention relates to a method of fabricating a resin surface layer, which includes the following steps:

(a) providing a base, made of a resin and including a plurality of additive particles randomly distributed in the base;

(b) changing the orientation of the additive particles to arrange the additive particles in a predetermined form; and

(c) drying the base to make a surface of the base exhibit a visual effect of 3D texture.

In the present invention, the material of the base in Step (a) is selected from a group consisting of PU, polyethylene (polyvinyl chloride), acrylic resin, polycarbonate, and epoxy resin. The additive particles in Step (a) are selected from a group consisting of pigments, dyes, colorants, coloring matters, and pearl powders.

In a preferred embodiment, after Step (a), a step of forming the base on a carrier is further included, in which the carrier is selected from a group consisting of a release paper, a woven fabric, a nonwoven fabric, leather, a microfiber, and a resin.

In the present invention, Step (b) includes applying an energy field to polarize the additive particles, so as to change the orientation of the additive particles. As used in the present invention, the word “polarization” refers to the reaction changing the orientation of the additive particles. The energy field is selected from a group consisting of light, heat, magnetic field, and electric field. As used herein, the word “orientation” refers to the distribution (density) of the additive particles, or the angle of the additive particles.

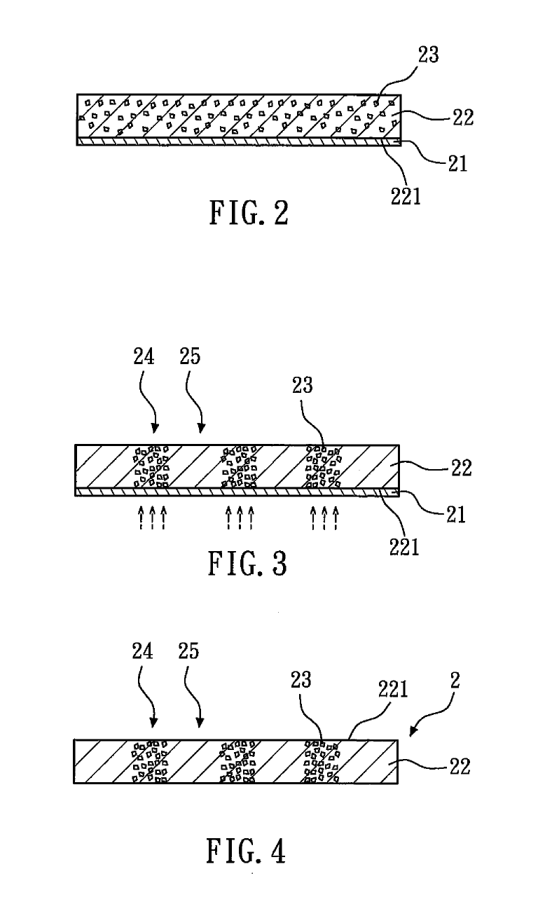

FIGS. 2 to 4 show schematic views illustrating a method of fabricating a resin surface layer according to a first embodiment of the present invention. First, referring to FIG. 2, a base 22 is provided. The material of the base 22 is a single-component PU resin (U-BEST POLYMER INDUSTRY CO., LTD®, AT-508E™). The base 22 includes a plurality of additive particles 23. In this embodiment, the additive particles 23 are pigment particles, and the material of the pigment is 41P series, TAH KONG CHEMICAL INDUSTRIAL CORP. The additive particles 23 are randomly distributed in the base 22.

Thereafter, the base 22 is formed on a release paper (Favini® ASTRAKAN™) 21, so that the base 22 has a surface 221. As the surface of the release paper 21 does not have textures, the surface 221 of the base 22 is smooth and does not have a physical texture of bumps and pits.

Then, referring to FIG. 3, a magnetic field is applied on the lower surface of the release paper 21 to polarize the additive particles 23, so as to change the distribution of the additive particles 23, so that the additive particles 23 have a predetermined density. As shown in the figure, additive particles 23 are dense in a first region 24, while no additive particle is in a second region 25.

Next, referring to FIG. 4, the base 22 is dried and the release paper 21 is removed, so as to form a surface layer 2. After inverting the base 22, the surface 221 of the base 22 can exhibit the visual effect of 3D texture. As shown in the figure, the first region 24 is a bright area, and the second region 25 is a dark area and exhibits a 3D texture of a plurality of cuboids.

Referring to FIG. 4 again, a schematic view of a resin surface layer according to the first embodiment of the present invention is shown. The resin surface layer 2 includes a base 22 and a plurality of additive particles 23. The base 22 has a surface 221, and the material of the base 22 is a resin selected from a group consisting of PU, polyethylene (polyvinyl chloride), acrylic resin, polycarbonate, and epoxy resin. In this embodiment, the material of the base 22 is a single-component PU resin (U-BEST POLYMER INDUSTRY CO., LTD®, AT-508E™). The surface 221 of the base 22 is smooth and does not have the physical texture of bumps and pits.

The additive particles 23 are located in the base 22. The additive particles 23 are selected from a group consisting of pigments, dyes, colorants, coloring matters, and pearl powders. In this embodiment, the additive particles 23 are pigment particles, and the material of the pigment is 41P series, TAH KONG CHEMICAL INDUSTRIAL CORP. The additive particles 23 are arranged in a predetermined form instead of randomly distributed in the base 22, so that the surface 221 of the base 22 can exhibit the visual effect of 3D texture. In this embodiment, the additive particles 23 have a predetermined density. That is, the density of the additive particles 23 in the first region 24 is different from that of the additive particles 23 in the second region 25, so that the first region 24 is a bright area, and the second region 25 is a dark area and exhibits the 3D texture of cuboids.

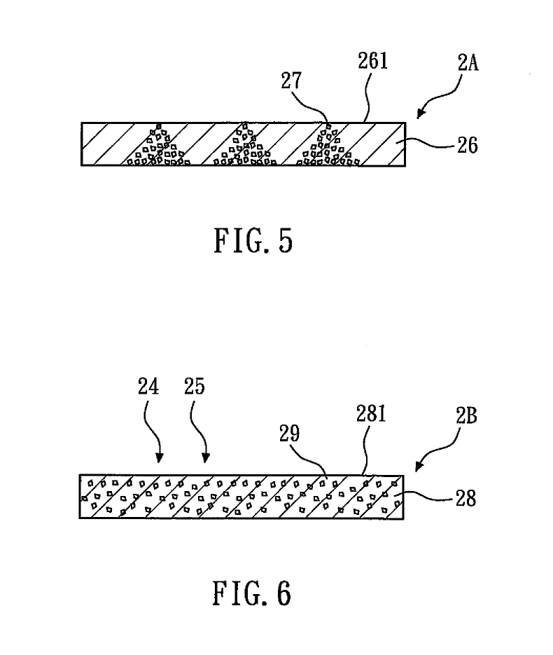

FIG. 5 shows a schematic view of a resin surface layer according to a second embodiment of the present invention. The resin surface layer 2A includes a base 26 and a plurality of additive particles 27. The base 26 is the same as the base 22 of the first embodiment. The additive particles 27 are substantially the same as the additive particles 23 of the first embodiment, except that the additive particles 27 are arranged into a triangular shape. Thus, the 3D texture of a plurality of prisms can be seen as if viewed from a surface 261 of the base 26.

FIG. 6 shows a schematic view of a resin surface layer according to a third embodiment of the present invention. The resin surface layer 2B includes a base 28 and a plurality of additive particles 29. The base 28 is the same as the base 22 of the first embodiment. The additive particles 29 are substantially the same as the additive particles 23 of the first embodiment, except that the orientation of the additive particles 29 is different. In this embodiment, after the additive particles 29 are polarized, the angles of the additive particles 29 are changed, so that the additive particles 29 have a predetermined density. As shown in the figure, the angle of the additive particles 29 in the first region 24 is different from the angle of the additive particles 29 in the second region 25. Therefore, although the additive particles 29 are uniformly distributed in the base 28, due to the distribution of additive particles at a specific angle, the first region 24 is a bright area, and the second region 25 is a dark area. Thus, a surface 281 of the base 28 exhibits the 3D texture of a plurality of cuboids, which is the same effect as that of the first embodiment.

Accordingly, in the present invention, the visual effects of any 3D textures can be achieved by controlling the energy field in order to control the orientation of the additive particles.

The above resin surface layer may be used alone, or may be used in a layer structure of a composite, which is described in the following embodiments.

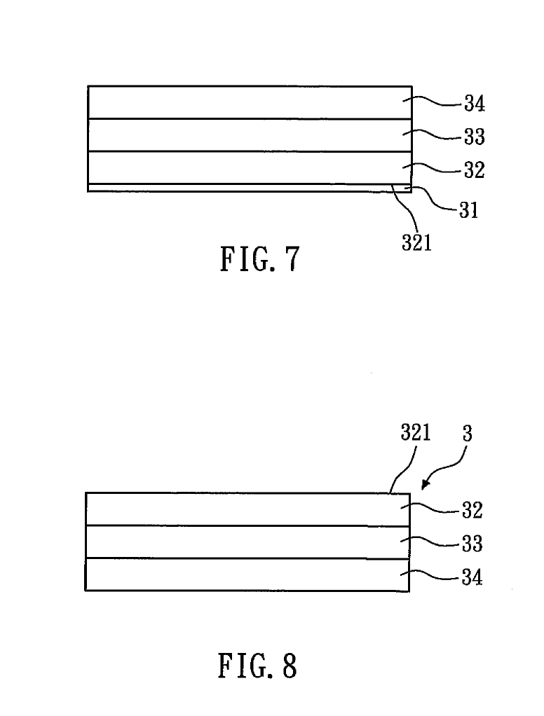

FIGS. 7 and 8 show schematic views of a method of fabricating the composite having a resin surface layer according to the first embodiment of the present invention. First, referring to FIG. 7, a release paper (Favini® ASTRAKAN™) 31 is provided. Next, a base is provided. The material of the base is a resin selected from a group consisting of PU, polyethylene (polyvinyl chloride), acrylic resin, polycarbonate, and epoxy resin. The base includes a plurality of additive particles selected from the group consisting of pigments, dyes, colorants, coloring matters, and pearl powders. The additive particles are randomly distributed in the base. In this embodiment, the material of the base is a single-component PU resin (U-BEST POLYMER INDUSTRY CO., LTD®, AT-508E™). The additive particles are pigment particles, and the material of the pigment is 41P series of TAH KONG CHEMICAL INDUSTRIAL CORP.

Then, the base is formed on the release paper 31 in the weight distribution of 120 g/m². After that, similar to the above, an energy field is applied to polarize the additive particles, so as to change the orientation of the additive particles. Next, the base is dried to form a surface layer 32 having a surface 321. The surface layer 32 is the same as the above resin surface layer.

Next, an adhesion layer 33 is formed on the surface layer 32. The material of the adhesion layer 33 is a two-component PU resin (U-BEST POLYMER INDUSTRY CO., LTD®, BD636M™), and has a weight distribution of 120 g/m². Then, the adhesion layer 33 is dried into a half-dried state at 70° C. After that, a bottom cloth layer 34 is formed on the adhesion layer 33, and the bottom cloth layer 34 is selected from a group consisting of a woven fabric, a non-woven fabric, leather, a microfiber, and a resin. In this embodiment, the bottom cloth layer 34 is artificial leather (San Fang). Finally, referring to FIG. 8, the release paper 31 is removed and inverted 180 degrees, and thus a composite 3 is formed.

Referring to FIG. 8 again, a schematic view of a composite having a resin surface layer according to the first embodiment of the present invention is shown. The composite 3 is fabricated by the method of the first embodiment. The composite 3 includes a bottom cloth layer 34, an adhesion layer 33, and a surface layer 32. The bottom cloth layer 34 is artificial leather (San Fang). The adhesion layer 33 is located on the bottom cloth layer 34, and the material of the adhesion layer 33 is a two-component PU resin (U-BEST POLYMER INDUSTRY CO., LTD®, BD636M™). The surface layer 32 is located on the adhesion layer 33. The surface layer 32 has a surface 321. The surface layer 32 has a base and a plurality of additive particles. The material of the base is a resin. The additive particles are arranged in a predetermined form instead of randomly distributed in the base, so that the surface 321 of the surface layer 32 can exhibit the visual effect of 3D texture, although the surface 321 is smooth and does not have a physical texture of bumps and pits.

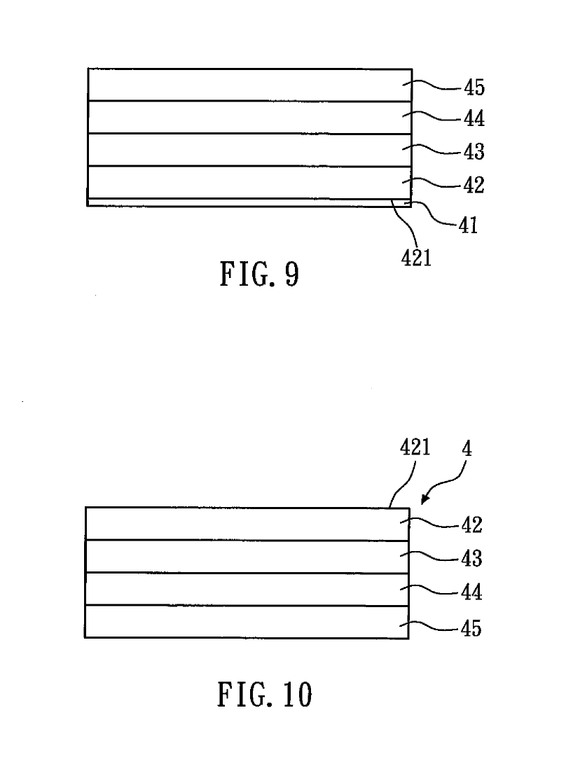

FIGS. 9 and 10 show schematic views of a method of fabricating the composite having a resin surface layer according to the second embodiment of the present invention. First, referring to FIG. 9, a release paper (Favini® ASTRAKAN™) 41 is provided. Next, a base is provided. The material of the base is resin and the base includes a plurality of first additive particles randomly distributed therein. In this embodiment, the material of the base is a single-component PU resin (U-BEST POLYMER INDUSTRY CO., LTD®, AT-508E™). The first additive particles are pigment particles, and the material of the pigment is 41P series of TAH KONG CHEMICAL INDUSTRIAL CORP.

Then, the base is formed on the release paper 41 in the weight distribution of 120 g/m². After that, similar to the above, an energy field is applied to polarize the first additive particles, so as to change the orientation of the first additive particles. Next, the base is dried to form a surface layer 42 having a surface 421. The surface layer 42 is the same as the above resin surface layer.

Next, an intermediate layer 43 is formed on the surface layer 42. The material of the intermediate layer 43 is resin and the intermediate layer 43 includes a plurality of second additive particles randomly distributed therein. The material of the intermediate layer 43 is selected from a group consisting of PU, polyethylene (polyvinyl chloride), acrylic resin, polycarbonate, and epoxy resin. The second additive particles are selected from a group consisting of pigments, dyes, colorants, coloring matters, and pearl powders. In this embodiment, the material of the intermediate layer 43 is a single-component PU resin (U-BEST POLYMER INDUSTRY CO., LTD®, AT-508E™). The second additive particles are pigment particles, and the material of the pigment is 41P series of TAH KONG CHEMICAL INDUSTRIAL CORP. Next, the intermediate layer 43 is formed on the surface layer 42 in the weight distribution of 120 g/m². It should be noted that the intermediate layer 43 can be directly dried without polarization.

Next, an adhesion layer 44 is formed on the intermediate layer 43. The material of the adhesion layer 44 is a two-component PU resin (U-BEST POLYMER INDUSTRY CO., LTD®, BD636M™), and has the weight distribution of 120 g/m². Thereafter, the adhesion layer 44 is dried into a half-dried state at 70° C. Next, a bottom cloth layer 45 is formed on the adhesion layer 44, and the bottom cloth layer 45 is selected from a group consisting of a woven fabric, a non-woven fabric, leather, a microfiber, and a resin. In this embodiment, the bottom cloth layer 45 is artificial leather (San Fang). Finally, referring to FIG. 10, the release paper 41 is removed and inverted 180 degrees, thus forming a composite 4.

Referring to FIG. 10 again, a composite having a resin surface layer according to the second embodiment of the present invention is shown. The composite 4 is fabricated by the method of the second embodiment and is substantially the same as the composite 3 of the first embodiment, except that the composite 4 further has an intermediate layer 43 between the surface layer 42 and the adhesion layer 44. The material of the intermediate layer 43 is resin, and the intermediate layer 43 includes a plurality of second additive particles randomly distributed therein.

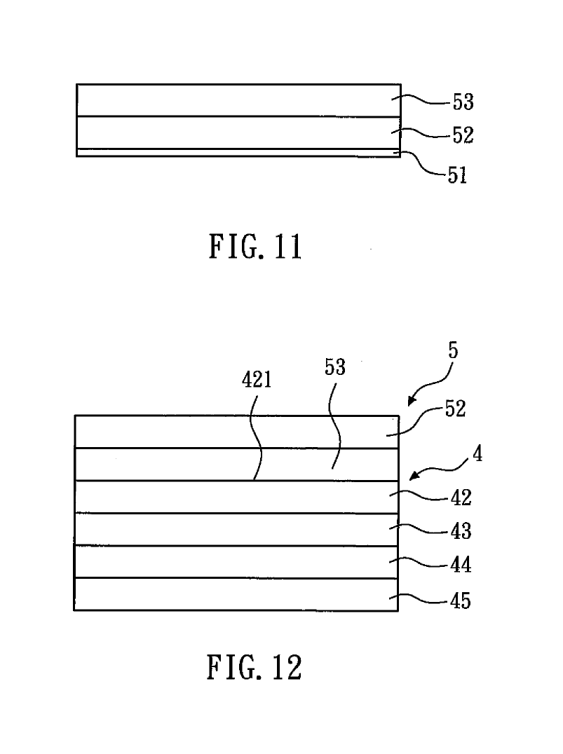

FIGS. 11 and 12 show schematic views of a method of fabricating the composite having a resin surface layer according to the third embodiment of the present invention. The fabrication method of this embodiment occurs subsequent to the second embodiment. First, referring to FIG. 11, a second release paper (Favini® ASTRAKAN™) 51 is provided. Next, a top layer 52 is formed on the second release paper 51. The material of the top layer 52 is resin and the top layer 52 includes a plurality of third additive particles randomly distributed therein. The material of the top layer 52 is selected from a group consisting of PU, polyethylene (polyvinyl chloride), acrylic resin, polycarbonate, and epoxy resin. The third additive particles are selected from the group consisting of pigments, dyes, colorants, coloring matters, and pearl powders. In this embodiment, the material of the top layer 52 is a single-component PU resin (U-BEST POLYMER INDUSTRY CO., LTD®, AT-508E™). The third additive particles are pigment particles, and the material of the pigment is 41P series of TAH KONG CHEMICAL INDUSTRIAL CORP. Next, the top layer 52 is formed on the second release paper 51 in the weight distribution of 120 g/m². It should be noted that the top layer 52 can be directly dried without polarization, and the third additive particles are required to have transparency.

Next, a second adhesion layer 53 is formed on the top layer 52. The material of the second adhesion layer 53 is a two-component PU resin (U-BEST POLYMER INDUSTRY CO., LTD®, BD636M™), and has a weight distribution of 120 g/m². Thereafter, the second adhesion layer 53 is dried into a half-dried state at 70° C.

Then, the second release paper 51, the top layer 52, and the second adhesion layer 53 are inverted, so as to adhere the second release paper 51 and the top layer 52 to the surface layer 42 of the composite 4 of the second embodiment by the use of the second adhesion layer 53. Finally, the second release paper 51 is removed, thus obtaining a composite 5.

Referring to FIG. 12 again, a schematic view of a composite having a resin surface layer according to the third embodiment of the present invention is shown. The composite 5 is fabricated by the method of the third embodiment. The composite 5 is substantially the same as the composite 4 of the second embodiment, except that the composite 5 further has a top layer 52 and a second adhesion layer 53. The second adhesion layer 53 is located on the surface layer 42, and the top layer 52 is located on the second adhesion layer 53. The material of the top layer 52 is resin, and the top layer 52 includes a plurality of third additive particles randomly distributed therein. The third additive particles are required to have transparency.

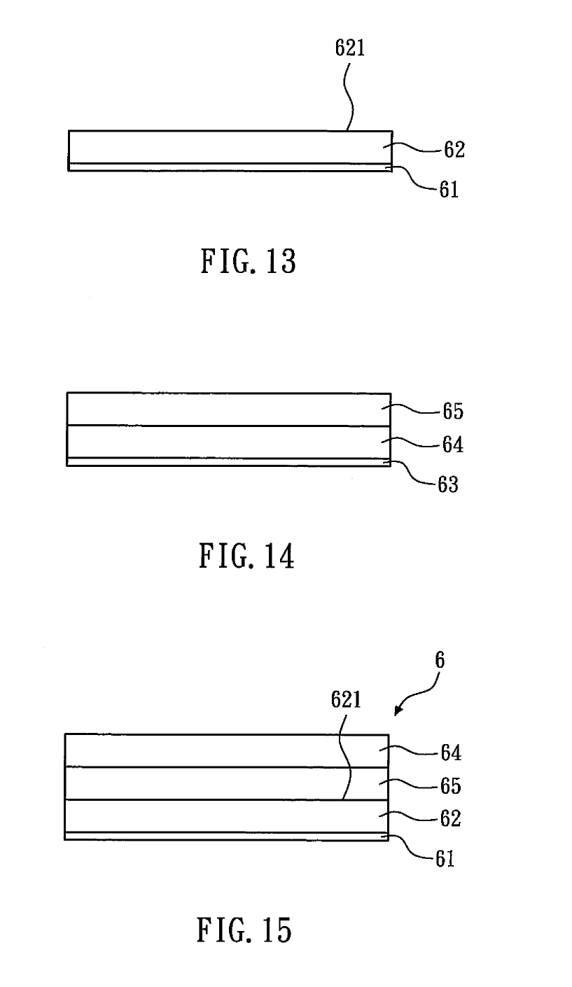

FIGS. 13 and 15 show schematic views of a method of fabricating the composite having a resin surface layer according to the fourth embodiment of the present invention. First, referring to FIG. 13, a bottom cloth layer 61 is provided. The bottom cloth layer 61 is selected from a group consisting of a woven fabric, a non-woven fabric, leather, a microfiber, and a resin. In this embodiment, the bottom cloth layer 61 is artificial leather (San Fang).

Next, a base is provided. The material of the base is a resin selected from the group consisting of PU, polyethylene (polyvinyl chloride), acrylic resin, polycarbonate, and epoxy resin. The base includes a plurality of first additive particles, and the first additive particles are selected from the group consisting of pigments, dyes, colorants, coloring matters, and pearl powders. The first additive particles are randomly distributed in the base. In this embodiment, the material of the base is a single-component PU resin (U-BEST POLYMER INDUSTRY CO., LTD®, AT-508E™). The first additive particles are pigment particles, and the material of the pigment is 41P series of TAH KONG CHEMICAL INDUSTRIAL CORP.

Then, the base is formed on the bottom cloth layer 61 in the weight distribution of 120 g/m². After that, similar to the above, an energy field is applied to polarize the first additive particles, so as to change the orientation of the first additive particles. Next, the base is dried to form a surface layer 62 having a surface 621. The surface layer 62 is the same as the above resin surface layer.

Next, referring to FIG. 14, a release paper (Favini® ASTRAKAN™) 63 is provided. Then, a top layer 64 is formed on the release paper 63. The material of the top layer 64 is resin, and the top layer 64 includes a plurality of second additive particles randomly distributed therein. The material of the top layer 64 is selected from a group consisting of PU, polyethylene (polyvinyl chloride), acrylic resin, polycarbonate, and epoxy resin. The second additive particles are selected from a group consisting of pigments, dyes, colorants, coloring matters, and pearl powders. In this embodiment, the material of the top layer 64 is a single-component PU resin (U-BEST POLYMER INDUSTRY CO., LTD®, AT-508E™). The second additive particles are pigment particles, and the material of the pigment is 41P series of TAH KONG CHEMICAL INDUSTRIAL CORP. Next, the top layer 64 is formed on the release paper 63 in the weight distribution of 120 g/m². It should be noted that the top layer 64 can be directly dried without polarization, and the second additive particles are required to have transparency.

Next, an adhesion layer 65 is formed on the top layer 64. The material of the adhesion layer 65 is a two-component PU resin (U-BEST POLYMER INDUSTRY CO., LTD®, BD636M™), and has a weight distribution of 120 g/m². Thereafter, the adhesion layer 65 is dried into a half-dried state at 70° C.

Next, referring to FIG. 15, the release paper 63, the top layer 64, and the adhesion layer 65 are inverted, so as to adhere the release paper 63 and the top layer 64 to the surface 621 of the surface layer 62 by the use of the adhesion layer 65. Finally, the release paper 63 is removed, thus obtaining a composite 6.

Referring to FIG. 15 again, a composite having a resin surface layer according to the third embodiment of the present invention is shown. The composite 6 is fabricated by the method of the third embodiment. The composite 6 includes a bottom cloth layer 61, a surface layer 62, an adhesion layer 65, and a top layer 64. The bottom cloth layer 61 is artificial leather (San Fang). The surface layer 62 is located on the bottom cloth layer 61. The surface layer 62 has a surface 621. The surface layer 62 has a base and a plurality of first additive particles. The material of the base is a resin, the first additive particles are arranged in a predetermined form instead of randomly distributed in the base, so that the surface 621 of the surface layer 62 can exhibit the visual effect of 3D texture, although the surface 621 of the surface layer 62 is smooth and does not have a physical texture of bumps and pits.

The adhesion layer 65 is located on the surface layer 62, and the material of the adhesion layer 65 is a two-component PU resin (U-BEST POLYMER INDUSTRY CO., LTD®, BD636M™). The top layer 64 is located on the adhesion layer 65. The material of the top layer 64 is resin, and the top layer 64 includes a plurality of second additive particles randomly distributed therein. The second additive particles are required to have transparency.

While several embodiments of the present invention have been illustrated and described, various modifications and improvements can be made by those skilled in the art. The embodiments of the present invention are therefore described in an illustrative but not restrictive sense. It is intended that the present invention should not be limited to the particular forms as illustrated, and that all modifications which maintain the spirit and scope of the present invention are within the scope defined in the appended claims.

What is claimed is:

1. A method of fabricating a resin surface layer, comprising:
(a) providing a base, made of a resin and including a plurality of additive particles randomly distributed in the base;
(b) changing an orientation of the additive particles, so that the additive particles are arranged in a predetermined form; and
(c) drying the base to make a surface of the base exhibit a visual effect of 3D texture.

2. The method as claimed in claim 1, wherein the material of the base of Step (a) is selected from a group consisting of PU, polyethylene (polyvinyl chloride), acrylic resin, polycarbonate, and epoxy resin, and the additive particles are selected from a group consisting of pigments, dyes, colorants, coloring matters, and pearl powders.

3. The method as claimed in claim 1, after Step (a), further comprising a step of forming the base on a carrier.

4. The method as claimed in claim 1, wherein in Step (b), an energy field is applied to polarize the additive particles, so as to change the orientation of the additive particles, and the energy field is selected from a group consisting of light, heat, magnetic field, and electric field.

5. The method as claimed in claim 1, wherein in Step (b), the distribution of the additive particles is changed, so that the additive particles have a predetermined density.

6. The method as claimed in claim 1, wherein in Step (b), an angle of the additive particles is changed, so that the additive particles are uniformly distributed in the base and have a predetermined angle distribution.

7. A resin surface layer, comprising:
a base, having a surface and made of a resin; and
a plurality of additive particles, located in the base, arranged in a predetermined form instead of randomly distributed in the base, so that the surface of the base exhibits a visual effect of 3D texture.

8. A method of fabricating a composite having a resin surface layer, comprising:
(a) providing a release paper;
(b) providing a base, the base being made of a resin and including a plurality of first additive particles randomly distributed in the base;
(c) forming the base on the release paper;
(d) changing the orientation of the first additive particles, so that the first additive particles are arranged in a predetermined form;
(e) drying the base to form a surface layer;
(f) forming a first adhesion layer on the surface layer;
(g) forming a bottom cloth layer on the first adhesion layer; and
(h) removing the release paper to form a composite.

9. The method as claimed in claim 8, wherein the first additive particles of Step (b) are selected from a group consisting of pigments, dyes, colorants, coloring matters, and pearl powders.

10. The method as claimed in claim 8, wherein in Step (d), an energy field is applied to polarize the first additive particles, so as to change the orientation of the additive particles, and the energy field is selected from a group consisting of light, heat magnetic field, and electric field.

11. The method as claimed in claim 8, after Step (e), further comprising a step of forming an intermediate layer on the surface layer, wherein the adhesion layer is formed on the intermediate layer in Step (f).

12. The method as claimed in claim 8, wherein the material of the intermediate layer is resin and the intermediate layer comprises a plurality of second additive particles randomly distributed therein.

13. The method as claimed in claim 8, after Step (h), further comprising:
(i) providing a second release paper;
(j) forming a top layer on the second release paper;
(k) forming a second adhesion layer on the top layer;
(l) adhering the second adhesion layer to the surface layer of the composite, so that the second release paper and the top layer are adhered to the surface layer of the composite; and
(m) removing the second release paper.

14. The method as claimed in claim 13, wherein the material of the top layer is resin and the top layer comprises a plurality of third additive particles randomly distributed therein.

15. A composite having a resin surface layer, comprising:
a bottom cloth layer, selected from a group consisting of a woven fabric, a non-woven fabric, leather, a microfiber, and a resin;
an adhesion layer, located on the bottom cloth layer; and
a surface layer, located on the adhesion layer and including a base and a plurality of first additive particles, wherein the material of the base is resin, the first additive particles are arranged in a predetermined form instead of randomly distributed in the base, so that a surface of the surface layer exhibits a visual effect of 3D texture.

16. The composite as claimed in claim 15, wherein the first additive particles are selected from a group consisting of pigments, dyes, colorants, coloring matters, and pearl powders, the composite further comprises an intermediate layer between the surface layer and the adhesion layer, and the material of the intermediate layer is resin and the intermediate layer comprises a plurality of second additive particles randomly distributed therein.

17. The composite as claimed in claim 16, further comprising a second adhesion layer and a top layer, wherein the second adhesion layer is located on the surface layer, and the top layer is located on the second adhesion layer, the material of the top layer is resin, and a plurality of third additive particles is randomly distributed in the top layer.
